(19) United States
(12) Patent Application Publication
(10) Pub. No.: US 2020/0353868 A1
(43) Pub. Date: Nov. 12, 2020

(54) EYE GAZE BASED LIVELINESS AND MULTI-FACTOR AUTHENTICATION PROCESS

(71) Applicant: Gentex Corporation, Zeeland, MI (US)

(72) Inventor: Jeremy A. Schut, Grand Rapids, MI (US)

(73) Assignee: Gentex Corporation, Zeeland, MI (US)

(21) Appl. No.: 16/848,380

(22) Filed: Apr. 14, 2020

Related U.S. Application Data
(60) Provisional application No. 62/844,187, filed on May 7, 2019.

(51) Int. Cl. B60R 1/12; B60R 1/04; G06F 21/32

(52) U.S. Cl. CPC B60R 1/12; B60R 1/04; B60R 2001/1253; B60R 2001/1223; B60R 2001/1215; G06F 21/32

(57) ABSTRACT

An authentication apparatus for a vehicle comprises a display device comprising a display screen configured to present display data and a scanning device configured to capture image data in a field of view. The field of view comprises a viewing region of the display device. The apparatus further comprises a controller configured to control the scanning device to capture the image data comprising a biometric data of a user and compare the biometric data of a user to an authentication template of the user. The controller is configured to validate a first authentication in response to the comparison indicating the biometric data of the user satisfies the authentication template. The controller is further configured to process a second authentication based on the image data. The second authentication comprises identifying a gaze direction of at least one eye of the user relative to a portion of the display screen.

### CROSS-REFERENCE TO RELATED APPLICATIONS

This application claims priority under 35 U.S.C. § 119(e) and the benefit of U.S. Provisional Application No. 62/844,187 entitled EYE GAZE BASED LIVELINESS AND MULTI-FACTOR AUTHENTICATION PROCESS, filed on May 7, 2019, by Jeremy A. Schut, the entire disclosure of which is incorporated herein by reference.

### TECHNOLOGICAL FIELD

The present invention generally relates to a vehicle display assembly, and, more particularly, to a display assembly comprising a scanning device.

### SUMMARY OF THE DISCLOSURE

According to one aspect of the present disclosure, an authentication apparatus for a vehicle is disclosed. The apparatus comprises a display device comprising a display screen configured to present display data and a scanning device configured to capture image data in a field of view. The field of view comprises a viewing region of the display device. The apparatus further comprises a controller configured to control the scanning device to capture the image data comprising a biometric data of a user and compare the biometric data of a user to an authentication template of the user. The controller is configured to validate a first authentication in response to the comparison indicating the biometric data of the user satisfies the authentication template. The controller is further configured to process a second authentication based on the image data. The second authentication comprises identifying a gaze direction of at least one eye of the user relative to a portion of the display screen.

According to another aspect of the present disclosure, a method for authenticating a user of a vehicle is disclosed. The method comprises capturing image data in a field of view, scanning the image data for biometric data, and comparing the biometric data to an authentication template for a user. The method further comprises validating a first authentication in response to the comparison indicating the biometric data satisfies the authentication template. The method further comprises processing a second authentication based on the image data in the field of view. The second authentication comprises identifying a gaze direction of at least one eye of a user relative to a portion of the display screen.

According to yet another aspect of the present disclosure, an authentication apparatus for a vehicle is disclosed. The apparatus comprises a display device comprising a display screen configured to present display data and an imaging device configured to capture image data in a field of view. The field of view comprises a viewing region of the display device. A controller is configured to control the imaging device to capture the image data comprising a biometric data of a user. The controller is further configured to control a first authentication procedure, wherein the controller is configured to: compare the biometric data of a user to an authentication template of the user; and validate the first authentication procedure in response to the comparison indicating the biometric data of the user satisfies the authentication template. The controller is further configured to control a second authentication procedure, wherein the controller is configured to display at least one symbol on the display screen in a first position; identify a gaze direction of at least one eye of the user relative to a portion of the display screen; and validate the second authentication in response to the gaze direction detected in the image date aligning with the first portion of the display screen. The controller is further configured to communicate an authorization of an operation of one or more systems of the vehicle in response to the validation of the first authentication and the second authentication. The first authentication and the second authentication are identified within a predetermined time period.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is an illustrative view of a display apparatus assembly comprising a user authentication device;

FIG. 1B is a detailed front view of a display apparatus assembly comprising a user authentication device demonstrating an authentication process;

FIG. 2A is a detailed view of exemplary image data demonstrating a gaze direction of a user of an authentication device;

FIG. 2B is a detailed view of exemplary image data demonstrating a gaze direction of a user of an authentication device;

FIG. 3A is a detailed view of a display apparatus comprising a user authentication device demonstrating an array of icons;

FIG. 3B is a detailed view of a display apparatus assembly comprising a user authentication device demonstrating a dynamic icon; and

FIG. 4 is a block diagram of a user authentication device in accordance with the disclosure.

### DETAILED DESCRIPTION

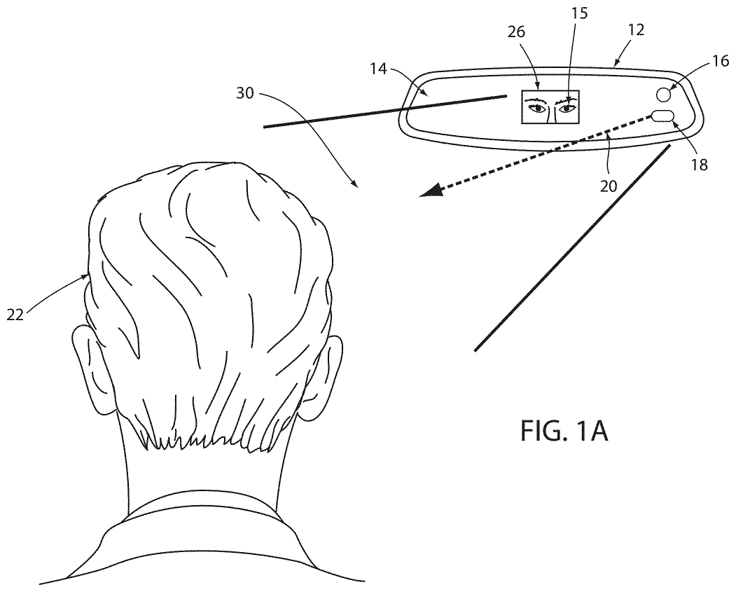

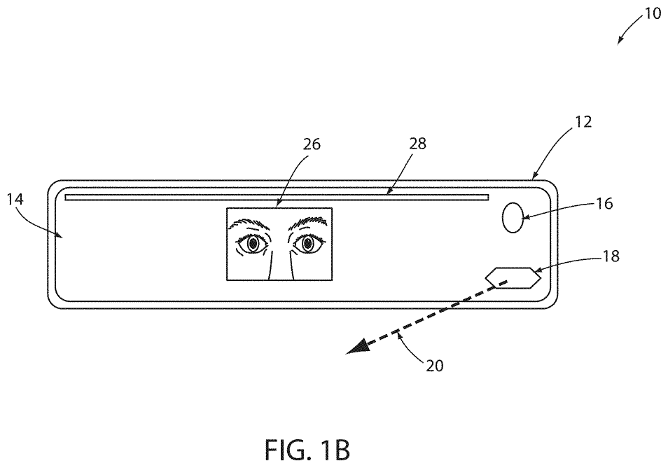

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the assembly of the element closer to an intended viewer of the mirror element, and the term “rear” shall refer to the assembly of the element further from the intended viewer of the mirror element. However, it is to be understood that the invention may assume various alternative orientations, except where expressly specified to the contrary. It is also to be understood that the specific devices and processes illustrated in the attached drawings, and described in the following specification are simply exemplary implementations of the inventive concepts defined in the appended claims. Hence, specific dimensions and other physical characteristics relating to the implementations disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

The terms “substantial,” “substantially,” and variations thereof as used herein are intended to note that a described feature is equal or approximately equal to a value or description. For example, a “substantially planar” assembly is intended to denote an assembly that is planar or approximately planar. Moreover, “substantially” is intended to denote that two values are equal or approximately equal. In some implementations, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes implementations having two or more such components unless the context clearly indicates otherwise.

Some implementations within this disclosure provide for a user authentication device configured to process or perform an identification function comprising a primary authentication process and a secondary authentication process. The primary authentication process may collect and capture a biometric data from the user and compare the biometric data to a user profile. The primary authentication process comprises biometric data that may be stored in the memory of the user authentication device during a set-up routine. The biometric data may comprise a plurality of biometric data types or examples to confirm the identity of an individual, such as but not limited to: iris patterns, fingerprinting, facial recognition software, etc.

The secondary authentication process may comprise a symbol identification process, which may cause the user authentication device to display a symbol matching an identifying symbol selected by a user and stored within a user profile. The secondary authentication process may also comprise capturing an eye gaze position or direction of the user in reference to a portion of a display screen. The eye gaze position may identify an icon selected by the user from an array of icons. In response to capturing the user's eye position, the secondary authentication process may comprise comparing the user's eye position to an icon displayed on a portion of the display assembly. Some implementations, the disclosure may provide for the user authentication device to compare the gaze direction to a user icon or symbol corresponding to a user profile of the authentication device. In this way, the authentication device may confirm the identity of the user by ensuring that the user can identify the user icon displayed on the authentication device.

Referring to FIGS. 1A and 1B, the disclosure provides for a user authentication device 10 operable to process and perform a primary and secondary authentication process. The authentication process may correspond to a biometric authentication, which may be followed by a secondary verification. The secondary verification may be determined based on image data captured in a field of view 30. In an exemplary implementation, the user authentication device 10 may be incorporated in an interior rearview display assembly 12, hereafter referenced as a display assembly 12. As shown, the display assembly 12 may be configured to be incorporated in an automotive vehicle. The display assembly 12 may correspond to an electro-optic assembly 14 having an electrochromic (EC) mirror element. As discussed herein, the display assembly 12 may include the user authentication device 10, such that an identity of an operator or passenger of the vehicle may be authenticated via an image-based eye-scan identification.

The eye-scan-identification function may utilize infrared illumination of an iris of one or more eyes 15 in order to illuminate the eyes 15 for the identification. Such illumination may be optimized in conditions allowing for a high optical transmittance in the near infrared (NIR) range. In some implementations, the disclosure may provide for an electrochromic (EC) stack of the electro-optic assembly 14 that may have a high light transmittance in the NIR range, for example, wavelengths of light ranging from 800 nm to 940 nm. Additionally, in some implementations, the display assembly 12 may comprise a plurality of light sources configured to illuminate at least one iris of the user of the vehicle.

To provide for the eye-scan-identification function, for example an iris scan, an image sensor 16 may be disposed proximate a rear assembly of the display assembly 12. The image sensor 16 may correspond to, for example, a digital charge-coupled device (CCD) or complementary metal-oxide-semiconductor (CMOS) active pixel sensor, although it may not be limited to these exemplary devices. The image sensor 16 may be in communication with at least one light source 18, which may correspond to one or more infrared emitters configured to output an emission 20 of light in the NIR range. In this configuration, the image sensor 16 may be configured to selectively activate the one or more infrared emitters corresponding to the at least one light source 18 to illuminate the iris, such that an identity of a user 22 of the vehicle may be determined.

In some implementations, a display property of the display assembly 12 may be controlled in response to the detection of one or more characteristics of the user 22 via the user authentication device 10. For example, one or more display characteristics of the display assembly 12 may be controlled via a controller 24 in communication with the user authentication device 10. Based on one or more ocular characteristics of the user 22 detected by the user authentication device 10, the controller 24 may be configured to control a brightness or visual attenuation of a display screen of the display assembly 12 depending on the time of day the user 22 is activating the user authentication device 10. In this way, the controller 24 may be configured to adjust one or more visual characteristics of image data displayed on the display screen of the display assembly 12. The adjustments may be based on various characteristics of the user 22 that may be detected in the data captured by the user authentication device 10. The adjustments may also adjust the brightness of an array of icons 54 or the frequency of a moving icon 58 displayed on the screen of the display assembly 12.

In an exemplary implementation, the emitters or the light source 18 of the user authentication device 10 may comprise a plurality of light-emitting diodes, which may be grouped in a matrix or otherwise grouped and disposed behind a rear assembly of the electro-optic device. In this configuration, the user authentication device 10 may be configured to illuminate the eyes 15 of the user 22, such that the image sensor 16 may capture image data including details of the irises of the eyes 15. In some implementations comprising an electro-optic assembly 14 having a high level of transmittance in the NIR range, the user authentication device 10 may utilize fewer or less intense LEDs. Examples of electro-optic assemblies having a high level of transmittance in the NIR range may correspond to assemblies comprising a transflective dielectric coating on the electro-optic assembly 14 as further disclosed herein.

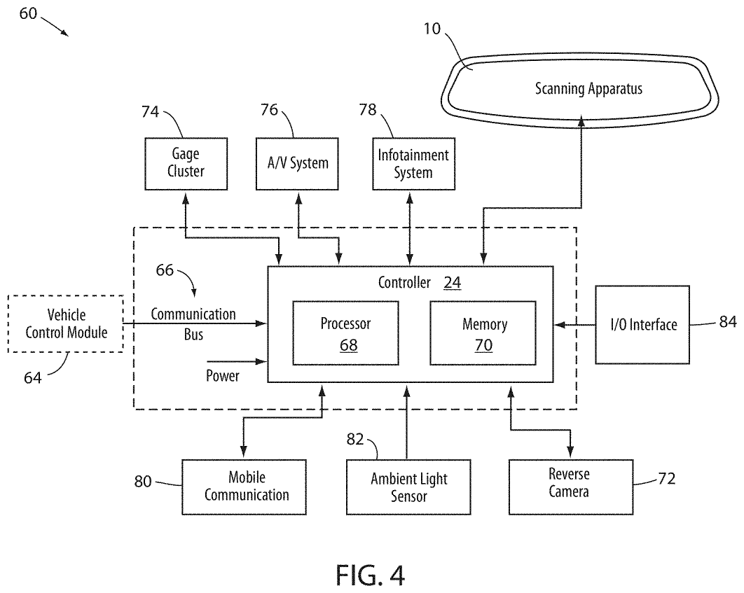

In some implementations, the controller 24 may be in communication with various vehicle systems and accessories via a communication bus or any other suitable communication interface. The controller 24 may comprise one of more processors or circuits, which may be configured to process image data received from the image sensor 16. In this configuration, the image data may be communicated from the image sensor 16 to the controller 24. The controller 24 may process the image data with one or more algorithms configured to determine an identity of the user of the vehicle. Further detailed discussion of the controller 24 and the various devices that may be in communication therewith are discussed in reference to FIG. 4.

As previously discussed, the controller 24 may further be in communication with a display screen 26. The display screen 26 may be disposed in the display assembly 12 and form a portion of a display surface. The controller 24 may further be configured to display image data received from one or more vehicle cameras (e.g. a rearview camera), and/or the image sensor 16 for display on the display screen 26. In this configuration, the user 22 of the vehicle may preview the image data as an aiming process for the capture of the image data for the biometric authentication.

As shown in FIGS. 1A and 1B, the user 22 may adjust a position of the eyes 15 shown on the display screen 26 to position the eyes 15 such that the image data may include the necessary features required to identify the user 22. The user 22 may adjust the position of the eyes 15 by physically moving the head of the user 22 or by physically adjusting an orientation of the display assembly 12. Also, the user authentication device 10 may alert the user 22, via an indicator bar 28, when the user 22 is in an ideal or non-ideal position within the field of view 30, such that the features necessary for authentication are displayed in the display screen 26 to complete one or more authentication processes as discussed herein. The indicator bar 28 may be adjacent to the display screen 26 and may comprise a plurality of lights, such as a plurality of LEDs and/or a plurality of audio or speaker devices. As the image sensor 16 captures the image data 50, the controller 24 may communicate to the indicator bar 28 to emit light from at least one of the plurality of LEDs instructing the user 22 to adjust a position within the field of view 30. Similarly, the controller 24 may output a sound indication from a speaker device to assist in the alignment.

The display screen 26 may correspond to a partial or full display mirror configured to display image data through at least a portion of the display assembly 12. The display screen 26 may be constructed utilizing various technologies, for example LCD, LED, OLED, or other display technologies. Examples of display assemblies that may be utilized with the disclosure may include U.S. Pat. No. 6,572,233 entitled “Rearview Mirror With Display,” U.S. Pat. No. 8,237,909 entitled “Vehicular Rearview Mirror Assembly Including Integrated Backlighting for a Liquid Crystal Display (LCD),” U.S. Pat. No. 8,411,245 entitled “Multi-Display Mirror System and Method for Expanded View Around a Vehicle,” and U.S. Pat. No. 8,339,526 entitled “Vehicle Rearview Mirror Assembly Including a High Intensity Display,” which are incorporated herein by reference in their entirety.

The various components of the electro-optic assembly 14 and the user authentication device 10 may be contained within a housing of the display assembly 12. In this way, the various components discussed herein may be substantially hidden from view of the user 22. Accordingly, the disclosure may provide for various advanced functions from the electro-optic assembly 14 and the user authentication device 10 while maintaining an appearance of a conventional rearview mirror.

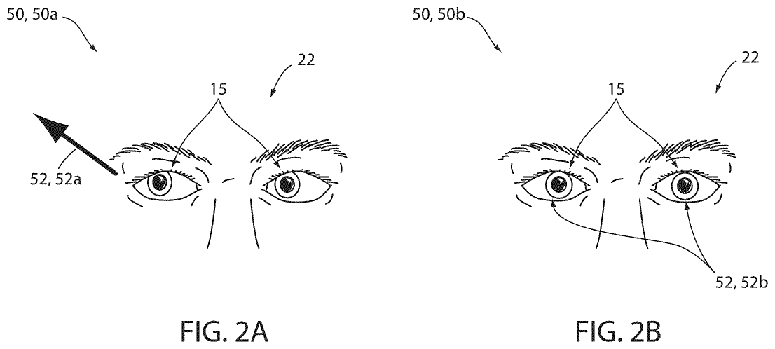

Referring to FIGS. 2A and 2B, first image data 50a and second image data 50b are shown. In some implementations, the controller 24 may be configured to monitor an eye position and/or a gaze direction of the eyes 15 of the user 22, which may be independent of the relative position of the pose of the user 22 captured in the image data 50. As depicted in FIG. 2A, the first image data 50a demonstrates the eyes 15 pitched in a gaze direction 52 in a side and upward direction 52a indicated by an arrow. In contrast, FIG. 2B depicts the second image data 50b demonstrating the eyes 15 focused in a gaze direction 52 directed generally forward direction 52b. In relation to the operation of the device 10, the gaze direction 52 may correspond to the eyes 15 of the user 22 aligned with or directed toward portion of the display screen 26, which may depict an icon or a symbol. Accordingly, the controller 24 may process the image data to determine the gaze direction 52 of the user 22 relative to the display screen 26.

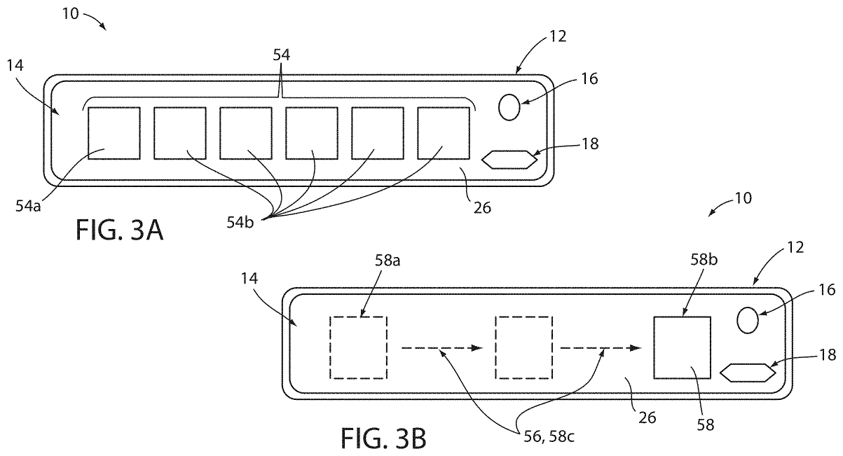

As further discussed in reference to FIGS. 3A and 3B, the controller 24 may be configured to determine and monitor the gaze direction 52 to select or identify a symbol or identifying mark or location on the display screen 26, which may be associated with a user profile. For example, the identifying mark may correspond to an identifying icon 54a that the controller 24 may utilize to authenticate the identity of the user 22. That is, if the gaze direction 52 identified by the controller 24 aligns with the identifying icon 54a among a plurality of non-identifying or decoy icons 54b, the controller 24 may authenticate the identity of the user 22. Accordingly, if the user 22 is able to identify the identifying icon, the controller 24 may utilize the identification as an indication of a confidence of the authentication by the authentication device 10. Similarly, the controller 24 may be configured to identify the gaze direction 52 to determine if the eyes 15 of the user 22 follow a changing position of a moving icon 58 demonstrated on the display screen 26. Accordingly, the controller 24 may determine a liveliness detection (e.g. anti-spoof detection) and/or an authentication of the user 22 based on the gaze direction 52.

The direction of the gaze may be calculated by the controller 24 based on a rotation and projected visual focal point of the eyes 15 of the user 22. The accuracy of such a determination may be improved or optimized by the controller 24 based on a calibration feature. The calibration feature may be configured to calibrate the determination of the gaze direction 52 of the user 22 based on the particular spatial relationships of features of the eyes 15 (e.g. ocular features, pupillary distance, retinal blood vessels, etc.) identified within the field of view 30. Though the authentication device 10 may be operable to identify the gaze direction 52 without the calibration routine, the generation of a user template and training of the determination of the gaze direction 52 for one or more common users may improve the operation of the device 10. Accordingly, the controller 24 may be configured to identify an ocular characteristic of the user 22, such as a pupillary distance and other ocular characteristics (e.g. corneal reflection, retinal vessel detection, etc), to identify the gaze direction 52 based on the image data 50. In this way, the device 10 may authenticate the user 22 and a liveliness of the user 22 in order to deter fraudulent or spoofing attempts to operate a vehicle or similarly connected device.

In some implementations, the eye position of the user 22 may be used in an identification function comprising a primary authentication process and/or a symbol identification process. The primary authentication process may include a biometric scan (e.g., iris scan) and verification that a user or person matches a previously identified profile or authentication template. The profile or template may include biometric data, recognition patterns, and additional information, which may be stored in the memory 70 (see FIG. 4). The biometric data may be captured during a setup routine and stored in the memory 70 as a portion of a user profile for an authorized user of the vehicle or similar device in connection with the authentication device 10. Accordingly, the authentication device 10 may be flexibly applied to suit a variety of authentication applications.

Following a successful identification of a previously identified user or user with a defined profile, the device 10 may continue to verify the primary authentication via the secondary authentication process. The secondary authentication process may include a symbol identification and/or pattern tracking assessment configured to verify the determination of the primary authentication. For example, the controller 24 may monitor the gaze direction 52 to determine if it aligns with the identifying icon 54a among the decoy icons 54b. That is, the identification of the identifying icon may be implemented to validate or authenticate the user based on the identification of a symbol (e.g., the identifying icon 54a) or a series of symbols that correspond to a user profile stored on or accessed by the device 10. The primary authentication process and the secondary authentication process may provide for a deterrent to fraudulent attempts by confirming the identity of the user 22. The secondary authentication process may provide for a deterrent in the form of an interactive challenge that may change in consecutive attempts to dynamically test the liveliness and comprehension of the user 22. In this way, the device 10 may be configured to reject fraudulent attempts to spoof or fool the authentication system via video, static images, models of the user, etc.

Referring again to FIGS. 2A and 2B, sample image data 50 is shown demonstrating the eyes 15 of the user 22 captured in the field of view 30. As previously discussed, the controller 24 may be configured to control a display property of the display assembly 12 based on one or more characteristics of the user 22 captured in the field of view 30 via the image sensor 16. In the examples discussed in reference to FIGS. 2A and 2B, the controller 24 may process the image data 50 captured by the image sensor 16 to identify one or more ocular characteristics of the user 22. Based on the ocular characteristics, the controller 24 may be configured to adjust a display characteristic (e.g., a brightness, visual attenuation, etc.) of the display assembly 12. In this way, the controller 24 may be configured to adjust one or more visual characteristics of image data displayed on the display assembly 12 based on various characteristics of the user 22. The adjustments of the visual characteristics of the image data may comprise improving the comfort of the user 22 by adjusting a brightness or intensity of the display screen 26 or display assembly 12 when ambient lighting conditions are sufficiently dark to cause the eyes 15 of the user 22 to dilate.

Referring now to FIGS. 3A and 3B, examples of the secondary authentication are discussed in reference to exemplary depictions of the authentication device 10. As previously discussed, the gaze direction 52 of the user 22 may be used in an identification function comprising the secondary authentication process and may comprise capturing the gaze direction 52 of the user 22 indicating a selection or indication of the identifying icon 54a among the decoy icons 54b. In response to capturing identifying the gaze direction 52, the controller 24 may compare the gaze direction 52 and corresponding icon 54 or symbol on the display screen 26. The icons 54 may correspond to depictions of objects, symbols, shapes, characters, or other visually identifiable characteristics displayed on the display screen 26. In this way, the display assembly 12 may operate as a user interface identifying a user selection indicated by the eye gaze direction 52.

In FIG. 3A, the controller 24 may display an array of icons 54 on the display screen 26. The array of icons 54 may be in a static position or may change in position or order over time or sequential depictions. In order to identify a user selection of the identifying icon 54a, the controller 24 may monitor the eyes 15 and the gaze direction 52 of the user 22. Upon identifying that the gaze direction 52 becomes fixed (less than a predetermined motion threshold for a predetermined time or detection period), the controller 24 may positively determine a selection according to the gaze direction 52. Based on the gaze direction 52, a corresponding gaze position on the display screen may be determined by the controller 24, and the gaze position may be compared with the positions of the identifying icon 54a and the decoy icons 54b, which may vary in successive authentication attempts or over time. As shown, the array of icons 54 may be displayed in locations aligned in a row on the screen 26 but may be displayed in other distributions or variations on the display screen 26.

In continued reference to FIG. 3A, the authentication device 10 may comprise an enrollment procedure or setup routine, wherein the user 22 may be prompted to select the identifying icon 54a for later identification among the decoy icons 54b. The identifying icon 54a or user icon may be displayed among the decoy icons 54b in various locations on the display screen 26. In operation, the user 22 may select the identifying icon 54a or user icon within the array of icons 54 by focusing the gaze direction 52 of the eyes 15 on the corresponding location of the screen 26. The controller 24 may compare the gaze direction 52 of the user 22 to the display of the identifying icon 54a within the array of icons 54. In response to the gaze direction 52 being aligned with the identifying icon 54a, the controller 24 may verify the identity of the user 22 or may prompt the user 22 to attempt the secondary authentication again. After a predetermined number of failures to identify the user icon or identifying icon 54a, the controller 24 may lock the authentication process and require additional authentication measures to unlock the authentication device 10 for operation.

In subsequent authentications, the display assembly 12 may change the order of the array of icons 54. In response to the change in the order of the array of icons 54, the gaze direction 52 of the user 22 required for authentication also may change with the changing location of the identifying icon 54a. In this way, the controller 24 may provide for variations in the authentication routines discussed herein that may prevent the use of models or static reproductions of the user 22 that may include a fixed gaze direction. In this way, the controller 24 may verify or authenticate the identity of the user 22 in two or more consecutive steps. The first step authenticates the user 22 via a biometric data comparison, and the second step authenticates the awareness and responsiveness of the user 22 to adjust the gaze direction 52 to dynamic changes in the icons 54 that change in consecutive authentications or over time in each authentication.

In some instances, the disclosure may also provide for the authentication device 10 to further test for a liveliness and responsiveness of the user 22 via a second authentication. For example, the authentication device 10 may be configured to identify changes in the gaze direction 52 over time that may correspond to a gaze pattern 56 of the user 22. The gaze pattern 56 may be detected by the controller 24 in response to changes in a position 58a, 58b of the moving icon 58 represented on the screen 26. The secondary authentication process may be implemented to deter fraudulent attempts to achieve an authentication by confirming the liveliness of the user 22. As discussed, the liveliness of the user 22 may correspond to the ability of the user 22 to move in a way representative of a living human as opposed to a static reproduction. Accordingly, testing the ability of the user to follow the gaze pattern 56 may provide an indication of an improved confidence that the authentication is being attempted by a bona fide user of the device 10.

In FIG. 3B, the moving icon 58 is shown in various positions along a path 58c to solicit the user 22 to focus the gaze direction on the moving icon 58, such that the controller 24 may detect the gaze pattern 56. Though the path 58c is depicted as a linear path on the screen 26, the path 58c may comprise any pattern including zig-zags, multiple linear movements, arc-shaped or circular movements, disappearing and reappearing instances in different locations, and nearly any variation or combination thereof. Accordingly, the controller 24 may display the moving icon 58 traveling across the display assembly 12 in a variety of patterns or continuous motions to solicit the user 22 to follow the moving icon 58, such that the gaze pattern 56 may be detected. In order to detect the gaze pattern 56, the gaze direction 52 may be monitored and sampled sequentially in coordination with the changes in the position of the moving icon 58 to track changes in the gaze direction 52 via the image sensor 16. Based on the changes in the gaze direction 52 of the user 22, the controller 24 may compare the changes to the path 58c in order to determine a correlation of the movements of the eyes 15 identified by the gaze direction 52 to the path 58c of the moving icon 58. Based on the correlation of the movements of the eyes 15 to the changes in the position of the moving icon, the controller 24 may validate the secondary authentication.

In some examples, the controller 24 may further validate or authenticate the gaze direction 52 by tracking the characteristics of the eyes 15. The characteristics of the eyes 15 identified by the controller 24 may include a dynamic response of the eyes or detection of motion including but not limited to a saccadic motion, a pupillary distance, a saccadian reaction time, two-eye relative saccadian motion, micro saccadian motion, and/or pupillary response time. For example, in some implementations, the user authentication device 10 may display a moving icon 58 and track the gaze direction 52 of the user 22 via the image sensor 16. While monitor the gaze direction 52 and gaze pattern 56 of the eyes 15, the controller 24 may further monitor the dynamic response of the user 22 to ensure that the response is representative of a human and also to ensure that one or more peculiarities, pauses, or other motion-related characteristics of the eyes 15 are detected to ensure that the subject depicted in the image data is, in fact, a living human person and, more specifically, the genuine person indicated by the biometric scan (e.g. iris scan) in the first authentication.

Referring now to FIG. 4, an exemplary implementation of a display system 60 comprising the user authentication device 10 and the display assembly 12 is shown. The controller 24 is shown in communication with the user authentication device 10, which may be incorporated in the display assembly 12 or positioned in various portions of the vehicle. The controller 24 may also be in communication with a vehicle control module 64 via a communication bus 66 of the vehicle. The communication bus 66 may be configured to deliver signals to the controller 24 identifying various vehicle states. For example, the communication bus 66 may be configured to communicate to the controller 24 a drive selection of the vehicle, an ignition state, a door open or ajar status, and/or a remote activation of the user authentication device 10. Such information and control signals may be utilized by the controller 24 to activate or adjust various states and/or control schemes of the user authentication device 10 and/or the display assembly 12.

The controller 24 may comprise a processor 68 having one or more circuits configured to receive the signals from the communication bus 66 and control the user authentication device 10. The processor 68 may be in communication with a memory 70 configured to store instructions to control operations of the user authentication device 10. For example, the controller 24 may be configured to store one or more characteristics or profiles utilized by the controller 24 to identify the user 22 of the vehicle. In this configuration, the controller 24 may communicate operating and identification information with the user authentication device 10 to identify the user of the vehicle. Additionally, based on the identification of the user 22, the controller 24 may be configured to control and/or communicate with additional systems of the vehicle. Such systems may include a security system, speed governor, radio/infotainment system, etc. In this way, one or more systems of the vehicle may be configured, controlled, or restricted based on the identity of the user 22.

In some implementations in response to an identification of a passenger or user of the vehicle, the controller 24 may access a database of stored user preferences to customize aspects of the vehicle or user experience. For example, the controller 24 may access and enable radio station presets according to a user's pre-established preferences. Navigation and/or map display settings may be changed or set according to a user's pre-established preferences. Additionally, the database may comprise navigation information comprising known or previously visited locations. In particular, a route to home, work, or other frequently visited locations may be preset upon identification of a user based on previous use or programming stored in the database.

The controller 24 may further be in communication with a reverse camera 72 or any other form of vehicle camera system. The controller 24 may receive image data from the reverse camera 72 corresponding to a rearward-directed field of view relative to the vehicle. In this configuration, the display screen 26 may provide for the rearward-directed field of view to be displayed when the display screen 26 is not utilized as for the identification process. The controller 24 may further be in communication with one or more of a gage cluster 74, an audio/video (A/V) system 76, an infotainment system 78, a media center, a vehicle computing system, and/or various other devices or systems of the vehicle. In various implementations, the controller 24 may display image data from at least one of the image sensor 16 and the reverse camera 72 on the devices 74-78.

In an exemplary embodiment, the processor 68 of the control controller 24 may correspond to one or more processors or circuits. In this configuration, the controller 24 may be configured to process image data received from the image sensor 16. The controller 24 may process the image data with one or more algorithms configured to determine an identity of the user 22 of the vehicle. With the identity of the user 22 or one or more passengers of the vehicle identified, the controller 24 may further be operable to control various systems or functions of the vehicle.

For example, the controller 24 may be configured to authorize various settings or restrictions of settings for the vehicle based on an identification of the user of the vehicle. The authorization may correspond to a speed governor, a payment authorization for toll roads or other transactional functions, a log of usage and timing for an identified user, etc. In some implementations, the user authentication device 10 may also be configured to document information corresponding to the usage and timing, for example, an identity of a driver or passenger, the number of passengers, a top speed of the vehicle, a maximum rate of acceleration, etc. In some implementations, the controller 24 may further be in communication with a global positioning system (GPS) that may also provide regional restrictions for the operation of the vehicle.

In some implementations, the controller 24 may utilize the identification of the user of the vehicle to report updates to an administrator of the vehicle. For example, in some implementations, the controller 24 may further be in communication with a mobile communication system 80. The mobile communication system 80 may be configured to communicate via various mobile communication protocols. Wireless communication protocols may operate in accordance with communication standards including, but not limited to: Institute of Electrical and Electronic Engineering (IEEE) 802.11 (e.g., WiFi™); Bluetooth®; advanced mobile phone services (AMPS); digital AMPS; global system for mobile communications (GSM); code division multiple access (CDMA); Long Term Evolution (LTE or 4G LTE); local multi-point distribution systems (LMDS); multi-channel-multi-point distribution systems (MMDS); radio frequency identification RFID; and/or variations thereof. In this configuration, the controller 24 may be configured to send an alert or message to the administrator of the vehicle in response to one or more predetermined events. The alert or message may correspond to a text message, data message, email, alert via an application operating on a smart device, etc.

The controller 24 may further be in communication with an ambient light sensor 82. The ambient light sensor 82 may be operable to communicate a light condition, for example a level brightness or intensity of the ambient light proximate the vehicle. In response to the level of the ambient light, the controller 24 may be configured to adjust a light intensity output from the display screen 26. The light intensity identified by the ambient light sensor 82 may additionally be adjusted based on the one or more ocular characteristics of the user 22 as discussed herein. In this configuration, the user of the controller 24 may adjust the brightness of the display screen 26 to provide image data captured by at least one of the image sensor 16 and the reverse camera 72.

The controller 24 may further be in communication with an interface 84 configured to receive one or more inputs configured to control at least one of the user authentication device 10 and the reverse camera 72. In some implementations, the interface 84 may be combined with one or more devices of the vehicle. For example, the interface 84 may form a portion of the gage cluster 74, the A/V system 76, the infotainment system 78, a display console and/or various input/output devices that may commonly be utilized in automotive vehicles (e.g., a steering switch, steering wheel controls, etc.). In this way, the disclosure provides for various control schemes for implementing the user authentication device 10 in a vehicle.

In some implementations, the interface 84 may alternatively or additionally correspond to a keypad, fingerprint scanner, facial scanner, etc. In such configurations, the controller 24 may be operable to authenticate or identify a passenger or user of the vehicle based on a multi-factor identification process. For example, the controller 24 may be configured to identify a user 22 or passenger of the vehicle in response to a first authentication and a second authentication. The first authentication may correspond to an iris scan detected via the user authentication device 10. The second authentication may correspond to a code or personal identification number (PIN) entry into the keypad, a fingerprint scan via the fingerprint scanner, a facial scan via a camera or the user authentication device 10, etc. In this way, the disclosure may provide various levels of authentication for a variety of applications.

The present disclosure may be used in combination with one or more systems, such as that described in U.S. Pat. Nos. 9,838,653; 9,244,249; 9,174,577; 8,960,629; 8,925,891; 8,814,373; 8,201,800; and 8,210,695; and U.S. Provisional Patent Application No. 61/704,869, the disclosures of which are hereby incorporated by reference in their entirety. Further, the present disclosure may be used with a rearview assembly, such as that described in U.S. Pat. Nos. 9,316,347; 8,885,240; 8,814,373; 8,646,924; 8,643,931; and 8,264,761; and U.S. Provisional Patent Application No. 61/707,625, the disclosures of which are hereby incorporated herein by reference in their entirety. It will be understood by one having ordinary skill in the art that construction of the described invention and other components is not limited to any specific material. Other exemplary implementations of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary implementations is illustrative only. Although only a few implementations of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary implementations without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. An authentication apparatus for a vehicle, the apparatus comprising:
a display device comprising a display screen configured to present display data;
a scanning device configured to capture image data in a field of view, wherein the field of view comprises a viewing region of the display device;
a controller configured to:
control the scanning device to capture the image data comprising a biometric data of a user;
compare the biometric data of a user to an authentication template of the user;
validate a first authentication in response to the comparison indicating the biometric data of the user satisfies the authentication template; and
process a second authentication based on the image data, wherein the second authentication comprises identifying a gaze direction of at least one eye of the user relative to a portion of the display screen.

2. The apparatus according to claim 1, wherein the display screen forms a viewing surface comprising a plurality of portions distributed over the viewing surface, wherein the controller is configured to identify a selected portion of the plurality of portions based on the gaze direction identified in the image data.

3. The apparatus according to claim 2, wherein the controller is further configured to control a display of at least one symbol on a first portion of the plurality of portions of the display screen.

4. The apparatus according to claim 3, wherein the controller is configured to validate the second authentication in response to the gaze direction detected in the image date aligning with the first portion of the display screen on which the symbol is depicted.

5. The apparatus according to claim 3, wherein the at least one symbol comprises a plurality of symbols comprising an identification symbol located in the first position and at least one control symbol located in a second position on the display screen.

6. The apparatus according to claim 5, wherein the at least one symbol comprises a plurality of icons comprising the identification symbol in the first position and a plurality of the control symbols distributed in at least a second position and a third position.

7. The apparatus according to claim 6, wherein the controller is configured to invalidate the second authentication in response to the gaze direction aligning with the second position or the third position of the plurality of control symbols.

8. The apparatus according to claim 5, wherein the at least one control symbol is a decoy symbol located in a spatially separated location on the display screen relative to the first position.

9. The apparatus according to claim 8, wherein the controller is configured to detect the gaze direction as aligning with the first position of the identification symbol or the second position of the at least one control symbol to determine the validation of the second authentication.

10. The apparatus according to claim 2, wherein the controller is further configured to:
monitor changes in the gaze direction to determine a gaze pattern of the at least one eye depicted in the image data.

11. The apparatus according to claim 10, wherein the gaze pattern comprises a plurality of gaze directions of the at least one eye identified over a display period.

12. The apparatus according to claim 11, wherein the controller is further configured to:
control a display of at least one moving symbol from a first position to at least a second position of the plurality of portions over the display period on the display screen.

13. The apparatus according to claim 12, wherein the controller is configured to validate the second authentication in response to the gaze pattern of the at least one eye aligning with the first position and the second position of the moving symbol on the viewing surface over the display period.

14. The apparatus according to claim 1, further comprising an emitter configured to output a detection emission configured to illuminate the at least one eye, wherein the biometric data comprises a reflection of the detection emission from the at least one eye.

15. The apparatus according to claim 1, wherein the detection emission comprises a near infrared band of light comprising wavelengths of light between 800 nm to 940 nm.

16. A method for authenticating a user of a vehicle, the method comprising:
capturing image data in a field of view;
scanning the image data for biometric data;
comparing the biometric data to an authentication template for a user;
validating a first authentication in response to the comparison indicating the biometric data satisfies the authentication template; and
processing a second authentication based on the image data in the field of view, wherein the second authentication comprises identifying a gaze direction of at least one eye of a user relative to a portion of the display screen.

17. The method according to claim 16, wherein the second authentication comprises:
displaying at least one symbol on a first portion of a plurality of portions distributed over a display surface the display screen; and
validating the second authentication in response to the gaze direction aligning with the first portion of the display surface.

18. The method according to claim 17, wherein the second authentication comprises:
invalidating the second authentication in response to the gaze direction aligning with a second portion of the plurality of portions of the display surface different from the first portion.

19. The method according to claim 16, wherein the second authentication comprises:
displaying at least one moving symbol on the display surface moving from a first position to at least a second position over the display period; and
validating the second authentication in response to the gaze direction aligning with the first position and the second position over the display period.

20. An authentication apparatus for a vehicle, the apparatus comprising:
a display device comprising a display screen configured to present display data;
an imaging device configured to capture image data in a field of view, wherein the field of view comprises a viewing region of the display device;
a controller configured to:
control the imaging device to capture the image data comprising a biometric data of a user;
control a first authentication procedure, wherein the controller is configured to:
compare the biometric data of a user to an authentication template of the user; and
validate the first authentication procedure in response to the comparison indicating the biometric data of the user satisfies the authentication template;
control a second authentication procedure, wherein the controller is configured to:
display at least one symbol on the display screen in a first position;
identify a gaze direction of at least one eye of the user relative to a portion of the display screen; and
validate the second authentication in response to the gaze direction detected in the image date aligning with the first portion of the display screen; and
communicate an authorization of an operation of one or more systems of the vehicle in response to the validation of the first authentication and the second authentication, wherein the first authentication and the second authentication are identified within a predetermined time period.
